(19) United States
(12) Patent Application Publication
(10) Pub. No.: US 2007/0034804 A1
(43) Pub. Date: Feb. 15, 2007

(54) Collimator and detector arrangement including a collimator

(76) Inventors: Ludwig Danzer, Wendelstein (DE); Silke Janssen, Langensendelbach (DE)

Correspondence Address: HARNESS, DICKEY & PIERCE, P.L.C., P.O. BOX 8910, RESTON, VA, 20195, US

(21) Appl. No.: 11/500,952

(22) Filed: Aug. 9, 2006

(30) Foreign Application Priority Data
Aug. 10, 2005 (DE) 10 2005 037 900.1

(51) Int. Cl. G01J 5/02

(52) U.S. Cl. 250/347

(57) ABSTRACT

A collimator is disclosed for a detector sensitive to radiation and having a contact electrode. The collimator includes a bottom element which is connectable to the contact electrode of the detector. In the bottom element, there is introducible into the recess in such a manner that when the bottom element is connected to the contact electrode, the electrical conductor is electrically connected to the contact electrode. A detector arrangement is also disclosed, having such a collimator.

### PRIORITY STATEMENT

The present application hereby claims priority under 35 U.S.C. §119 on German patent application number DE 10 2005 037 900.1 filed Aug. 10, 2005, the entire contents of which is hereby incorporated herein by reference.

### FIELD

The invention generally relates to a collimator for a detector sensitive to radiation, and/or generally relates to a detector arrangement including at least two detectors sensitive to radiation and at least two collimators.

### BACKGROUND

A collimator is used, for example, in the imaging by way of an X-ray device, e.g. a computer tomography device. The computer tomography device has, e.g., an X-ray system arranged on a rotating frame with an X-ray source and an X-ray detector. As a rule, the X-ray detector is constructed of a multiplicity of detector modules which are joined together linearly or two-dimensionally.

Each detector module of the X-ray detector includes, for example, a semiconductor detector sensitive to X-radiation and includes a multiplicity of detector elements. Above each semiconductor detector, a collimator is arranged for reducing stray radiation influences which has the effect that only X-radiation of a particular spatial direction reaches the semiconductor detector. The X-radiation impinging on the semiconductor detector is converted by the semiconductor detector into electrical signals which form the starting point for the reconstruction of an image of an object examined by way of the computer tomography device.

In DE 43 44 252 A1, the structure of a detector element of a semiconductor detector is described. An X-ray detector for a computer tomography device can be built up from a multiplicity of semiconductor detectors in each case including a number of detector elements. Each detector element has on its upper side and underside in each case an electrode to which, when the detector element is operating, a voltage is to be applied in order to be able to detect X-radiation which has impinged on the detector element in the form of electrical signals.

If such semiconductor detectors are in each case to be used as a component of a detector module for building up a so-called planar array detector in which the detector modules are to be joined together two-dimensionally, the problem arises of electrically contacting the electrodes of the semiconductor detectors, particularly the electrodes of the semiconductor detectors facing the X-ray source or the collimator, respectively.

Whereas a detector module in an X-ray detector of conventional construction, in which individual detector modules are arranged behind one another on a circular arc, can be electrically contacted via a cable conducted to a circuit board on the side as can be seen from US 2005/0029463 A1, this configuration is no longer possible in the case of a planar array detector since there is no longer any free space to the side of the detector modules due to the two-dimensional arrangement of the detector modules.

### SUMMARY

A collimator or a detector arrangement is constructed, in at least one embodiment, in such a manner that a detector associated with the collimator, and for example provided for building up a planar array detector, can be electrically contacted in a simple manner.

According to at least one embodiment of the invention, a collimator is provided for a detector sensitive to radiation and having a contact electrode, the collimator including a bottom element which can be connected to the contact electrode of the detector. In the bottom element there is a recess, wherein an electrical conductor can be introduced into the recess in such a manner that when the bottom element is connected to the contact electrode, the electrical conductor is electrically connected to the contact electrode.

It is therefore provided in at least one embodiment, especially for building up a planar array detector which has a multiplicity of detectors arranged closely next to one another, avoiding intermediate spaces if possible, to construct a collimator intended for a detector in such a manner that the contact electrode of the detector associated with the collimator can be electrically contacted via an electrical conductor run in the recess of the collimator. It is thus possible to achieve electrical contacting of the contact electrode of the detector facing the collimator without having to run an electrical connection through the detector or provide electrical lines of otherwise special construction for contacting the contact electrode of the detector facing the collimator.

On its side facing away from the collimator, the detector, as a rule, has a number of electrodes or one pixelated electrode by which the detector elements of the detector are formed. Assuming a vertical structure of a detector module having the detector, a different potential can be applied to these electrodes from the bottom in a simple manner than to the electrode facing the collimator so that a voltage drop occurs across each detector element of the detector.

According to one embodiment of the invention, the detector is a semiconductor detector which exhibits GaAs, CdTe or some other semiconductor material suitable, in particular, for detecting X-radiation, as semiconductor material.

Variants of embodiments of the invention provide that the bottom element of the collimator provided with the recess is constructed of an electrically insulating material, preferably of an electrically insulating synthetic material. This material can be processed easily so that the recess can be introduced into the bottom element without problems. In addition, the electrically insulating material has the effect that the collimator plates of the collimator, which, as a rule, are present, are free of voltage and thus no unwanted effects occur in the operation of a detector provided with such a collimator.

According to one embodiment of the invention, the bottom element of the collimator is bonded to the contact electrode of the detector. The bonding joint also fixes the electrical conductor introduced into the recess so that the bonding joint also achieves reliable contact of the electrical conductor with the contact electrode of the detector.

Variants of embodiments of the invention provide that the electrical conductor is a metallic wire, an electrically conductive foil or also an electrically conductive film which can be compacted. All these variants are suitable for producing a reliable electrical contact between the electrical conductor and the contact electrode of the detector.

According to an example embodiment of the invention, the recess in the collimator is constructed in the form of a groove in which the electrical conductor can be introduced in a simple manner.

If, as in accordance with an embodiment of the invention, the collimator extends over a number of detectors arranged behind one another, all contact electrodes in each case facing a collimator, of the detectors via which the collimator extends, can be electrically contacted via only one electrical conductor introduced into the recess of the collimator, for example an electrical wire run through a groove of the collimator.

According to another variant of an embodiment of the invention, in each case one collimator is provided for one detector. The collimator can be constructed in such a manner that an electrical conductor is in each case run through the recess in the bottom element, the electrical conductor having contact areas on both sides of the collimator. If the detectors are arranged in one row in the form of a detector bar and are in each case provided with a collimator, a continuous electrical contact is built up across the detector bar via the contact areas of the electrical conductors of the collimators so that all contact electrodes of the detectors of a detector bar can also be electrically contacted via one line. To build up a planar array detector, a number of such detector bars are arranged next to one another.

A detector arrangement, in at least one example embodiment, includes at least two detectors sensitive to radiation, which in each case have a contact electrode and are arranged behind one another, and at least two collimators which in each case have a bottom element with a recess, wherein a collimator is in each case arranged with its bottom element on the contact electrode of a detector and wherein an electrical conductor is run through the recesses of the collimators in such a manner that the electrical conductor is electrically connected to the contact electrodes of the detectors. The detector arrangement may be a detector bar in which a number of detectors are arranged behind one another which in each case have a collimator. In this manner, it is again sufficient to run only one electrical conductor through the recesses of the collimators arranged behind one another in order to electrically contact all contact electrodes, in each case facing a collimator, of the detectors of the detector bar.

As a development of the detector arrangement, its collimators can be arranged as already described above, which produces the advantages mentioned.

### BRIEF DESCRIPTION OF THE DRAWINGS

Example embodiments of the invention are shown in the attached diagrammatic drawings, in which:

FIG. 1 shows a computer tomography device in a diagrammatic, partially block diagram-like representation,

FIG. 2 shows a detector module of the computer tomography device from FIG. 1,

FIG. 3 shows the detector module from FIG. 2 in a perspective representation,

FIG. 4 shows a detector module with a collimator with electrical contact areas on both sides,

FIG. 5 shows the side view of the collimator from FIG. 4 in the direction of arrow V from FIG. 4, and

FIG. 6 shows a detector bar with a collimator extending over a number of detectors.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms. “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

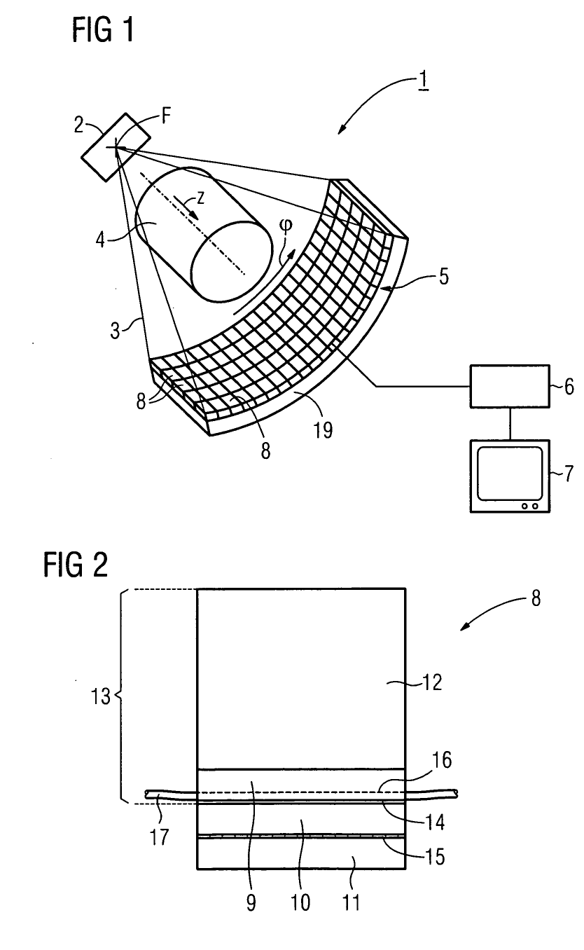

FIG. 1 shows a computer tomography device 1 in a diagrammatic, partially block diagram-like representation. The computer tomography device 1 includes an X-ray source 2 from the focus F of which an X-ray beam 3 is emitted which is shaped, for example, like a fan or pyramid by use of diaphragms not shown in FIG. 1 but known per se. The X-ray beam 3 penetrates an object to be examined 4 and impinges on an X-ray detector 5.

The X-ray source 2 and the X-ray detector 5 are arranged opposite one another, in a manner not shown in FIG. 1, on a rotating frame of the computer tomography device 1 which rotating frame can be rotated in the f direction around the system axis Z of the computer tomography device 1. When the computer tomography device 1 is in operation, the X-ray source 2 arranged on the rotating frame and the X-ray detector 5 rotate around the object under examination 4 and X-ray recordings of the object under examination 4 are obtained from different directions of projection. For each projection, X-radiation which has passed through the object under examination 4 and has been weakened by passing through the object under examination 4 impinges on the X-ray detector 5, the X-ray detector 5 generating electrical signals which correspond to the intensity of the X-radiation which has impinged. From the signals determined by means of the X-ray detector 5, an image computer 6 calculates in a manner known per se one or more two- or three-dimensional images of the object under examination 4, which can be represented on a display device 7.

In the case of the present example embodiment, the X-ray detector 5 has a multiplicity of detector modules 8 which are arranged next to one another in the f direction and in the Z direction on a detector arc 19, which represents a partial cylindrical surface, and form the planar X-ray detector 5.

A detector module 8 of the X-ray detector 5 is shown by way of example in FIG. 2. The detector module 8 has a vertical structure in which a detector 10 is arranged on a circuit board 11 in the case of the present example embodiment. However, the detector 10 can also be arranged directly on evaluating electronics associated with the detector 10. Above the detector 10, there is a collimator 13 which is intended to ensure that only X-radiation from a particular spatial direction can reach the detector 10.

In the case of the present example embodiment, the detector 10 is a semiconductor detector 10 which has an upper contact electrode 14 and a pixelated lower contact electrode 15. A pixelated contact electrode is understood to be an electrode which is structured, for example, in the form of a grid so that, in reality, there are many individual electrodes which in each case define a detector element of the semiconductor detector 10. The semiconductor detector 10 is constructed of a semiconductor material known per se, for example GaAs, and, in a manner not shown explicitly, has a multiplicity of detector elements due to the pixelation.

When the X-ray detector 5 is in operation, a voltage must be applied to each detector element of each semiconductor detector 10 so that X-radiation impinging on the semiconductor detector 10 can be detected in the form of electrical signals. Whereas the pixelated electrode 15 can be contacted electrically in a simple manner via the circuit board 11, this is more difficult for the electrode 14. The electrode 14 must be contacted in such a manner that the joining together of the detector modules 8 with avoidance of intermediate spaces between the detector modules 8 is not impeded.

For this reason, it is proposed to electrically contact the electrode 14 via the collimator 13 so that a voltage can be applied between the electrodes 14 and the pixelated electrode 15. To achieve this, the collimator 13 has a bottom element 9 which is constructed of an electrically insulating material, preferably of an electrically insulating synthetic material. In the bottom element 9, there is a recess 16 which has the shape of a groove in the case of the present example embodiment. The groove 16 is constructed in such a manner that it can accommodate an electrical conductor.

If the collimator 13 is arranged on the electrode 14 of the semiconductor detector 10 and if there is an electrical conductor 17 in the groove 16, the electrical contact is established between the electrical conductor 17 and the electrode 14 of the semiconductor detector 10. As a rule, the collimator 13 is bonded to the electrode 14 of the semiconductor detector 10, the bonding joint being arranged in such a manner that it also results in fixing the electrical conductor 17 run in the groove 16 relative to the electrode 14.

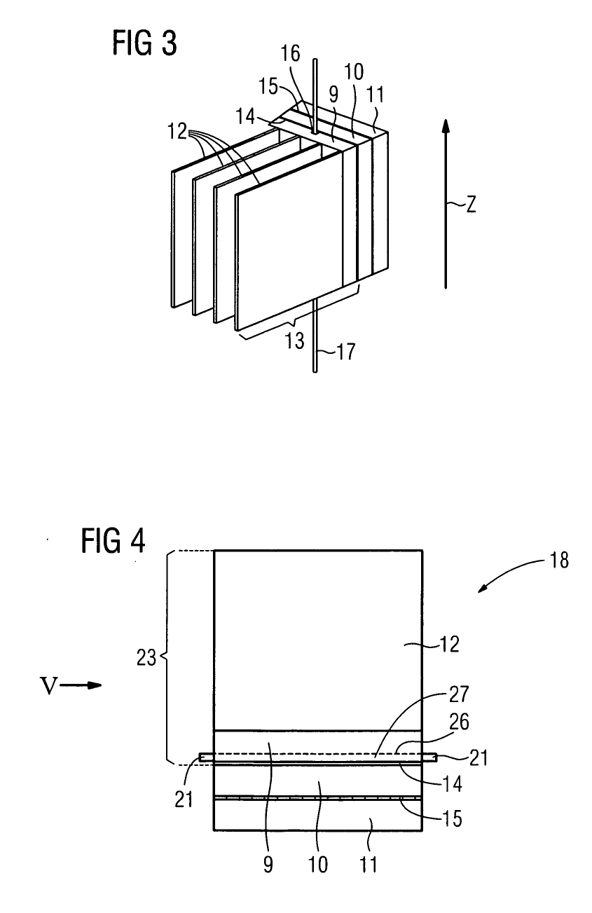

The detector module 8 of FIG. 2 is again shown in a perspective representation in FIG. 3, only four collimator plates 12 of the collimator 13 being shown for reasons of simpler representation. The groove 16 which extends through the bottom element 9 of the collimator 13 can also be seen.

According to an example embodiment, each detector module 8 has a collimator 13, the collimators 13 being aligned toward the semiconductor detectors 10 in the Z direction in such a manner that five detector modules 8, arranged behind one another in the Z direction to form a detector bar, or electrodes 14 of the semiconductor detectors 10 of the detector modules 8, respectively, are electrically contacted with only one electrical conductor 17 which is run through the grooves 16 of five collimators 13 of detector modules 8 in the case of the present exemplary embodiment. Since, as already mentioned, the pixelated electrodes 15, i.e. the multiplicity of individual electrodes of the semiconductor detectors 10 are in each case preferably electrically contacted via their circuit board 11, a voltage, which is in the range of approx. 1000 V, can thus be applied to each detector element of each semiconductor detector 10 in order to be able to detect, in the form of electrical signals, X-radiation impinging on the semiconductor detectors 10 when the X-ray detector 5 is in operation.

FIG. 4 shows an alternative embodiment of a detector module 18 which only differs from the detector module 8 in the structure of the collimator 23 which is why components of the detector module 18 which correspond to components of the detector module 8 are provided with the same reference symbols. In the collimator 23, an electrical conductor 27 is already integrated in a groove 26. On both sides of the electrical conductor 27 running through the groove 26, there are contact areas 21 which are distinguished by the fact that they have a certain flexibility. The flexibility can be achieved, for example, by a leaf-spring-like construction of the contact areas 21.

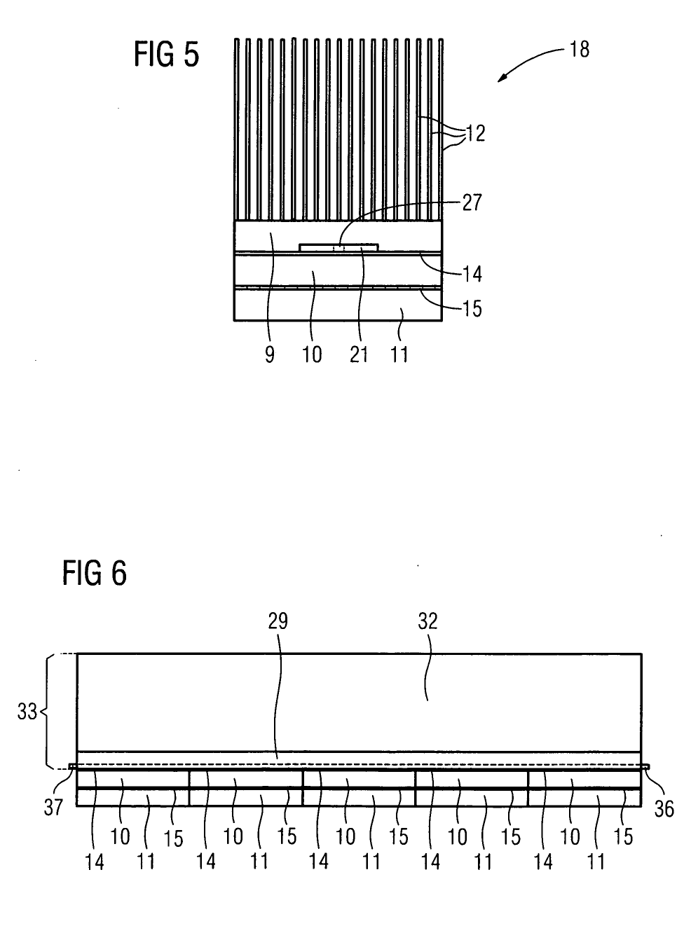

As can be seen from the side view of the detector module 18 from FIG. 4, shown in FIG. 5, the contact areas 21 of the collimator 23 extend over a relatively large area in order to ensure that, when detector modules 18 are arranged next to one another, there is a contact between the electrical conductors 27 of the collimators 23. If it is assumed again that five detector modules 18 are arranged behind one another in the Z direction in order to build up a detector bar, the collimators 23 of these detector modules 18 are aligned in such a manner that, when they are joined together, there will be a continuous electrical contact from the first to the fifth detector module 18 via the contact areas 21. Accordingly, it is sufficient to electrically contact an electrical conductor 27 of an outer detector module 18 via its contact area 21 in order to apply a voltage to the semiconductor detectors 10 of the detector bar. Each collimator 23 is again preferably bonded to the electrode 14 of a semiconductor detector 10.

If the collimator 23 is modified in such a manner that it has such contact areas, connected to an electrical conductor, even on all four sides, there is the possibility of forming the electrical contacting of the detector modules or of the electrodes 14, in each case facing a collimator, of the semiconductor detectors 10 in this manner also in the f direction so that an electrical conductor of a detector module only needs to be contacted once in order to be able to apply a voltage to all electrodes 14 of the semiconductor detectors 10.

According to another example embodiment of the invention, shown in FIG. 6, a collimator 33 is constructed in such a manner that it extends over a detector bar in the Z direction. In this arrangement, the collimator 33 per se is constructed like the collimator 13, the difference being that it is extended in the Z direction. That is to say, the collimator 33 also has collimator plates 32, a bottom element 29 and a continuous recess in the form of a groove 36.

If the semiconductor detectors 10 arranged in each case on a circuit board 11 or possibly also on a common circuit board are arranged behind one another in the Z direction, the collimator 33 can be arranged above the five semiconductor detectors 10 by way of a bonding joint. An electrical conductor 37 running through the groove 36 ensures the electrical contacting of the electrodes 14 of the semiconductor detectors 10. Thus, a number of semiconductor detectors 10 can be contacted in a simple manner with only one electrical conductor 37 also in this embodiment of a collimator 33.

The electrical conductor can be a metallic wire, a conductive foil or a conductive film. However, other suitable electrical conductors can also be used.

The bottom element of the collimator does not necessarily have to be produced from an insulating synthetic material. Instead, ceramics or other insulating material can also be used if advantageous.

Furthermore, a detector bar does not necessarily have to have five detector modules but can also have more or fewer detector modules.

Neither does a detector bar have to be necessarily built up as part of the invention.

Embodiments of the invention have been described above using the example of a computer tomography device. However, the invention can also be used in other, preferably X-ray devices.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A collimator for a detector sensitive to radiation and including a contact electrode, the collimator comprising:
a bottom element, connectable to the contact electrode of the detector, the bottom element including a recess, and an electrical conductor being introducible into the recess such that when the bottom element is connected to the contact electrode, the electrical conductor is electrically connected to the contact electrode.

2. The collimator as claimed in claim 1, wherein the detector is a semiconductor detector.

3. The collimator as claimed in claim 1, wherein the bottom element is constructed of an electrically insulating material.

4. The collimator as claimed in claim 1, wherein the bottom element is constructed of an electrically insulating synthetic material.

5. The collimator as claimed in claim 1, wherein the bottom element is bonded to the contact electrode.

6. The collimator as claimed in claim 1, wherein the electrical conductor is constructed in the form of at least one of a wire, a conductive foil and a conductive film.

7. The collimator as claimed in claim 1, wherein the recess is constructed in the form of a groove.

8. The collimator as claimed in claim 1, wherein the collimator extends over a number of detectors.

9. The collimator as claimed in claim 1, wherein the electrical conductor is run through the recess, wherein the electrical conductor has contact areas on both sides of the collimator.

10. A detector arrangement, comprising:
at least two detectors sensitive to radiation, each including a contact electrode, the detectors being arranged behind one another; and
at least two collimators, each including a bottom element with a recess, a collimator being arranged with a bottom element of the collimator on the contact electrode of a detector, an electrical conductor being run through the recesses of the collimators such that the electrical conductor is electrically connected to the contact electrodes of the detectors.

11. The detector arrangement as claimed in claim 10, wherein the detectors are semiconductor detectors.

12. The detector arrangement as claimed in claim 10, wherein the bottom element of a collimator is constructed of an electrically insulating material.

13. The detector arrangement as claimed in claim 10, wherein the bottom element of a collimator is constructed of an electrically insulating synthetic material.

14. The detector arrangement as claimed in claim 10, wherein the bottom element of a collimator is bonded to the contact electrode of a detector.

15. The detector arrangement as claimed claim 10, wherein the electrical conductor is constructed in the form of at least one of a wire, a conductive foil and a conductive film.

16. The detector arrangement as claimed in claim 10, wherein the recess in a collimator is constructed in the form of a groove.

17. The detector arrangement as claimed in claim 10, wherein a number of detectors provided with collimators are arranged behind one another and form one detector bar.

18. The collimator as claimed in claim 2, wherein the bottom element is constructed of an electrically insulating material.

19. The detector arrangement as claimed in claim 11, wherein the bottom element of a collimator is constructed of an electrically insulating material.

20. A detector arrangement, comprising:
at least one detectors; and
at least one collimator as claimed in claim 1.
